(19) United States
(12) Patent Application Publication
(10) Pub. No.: US 2025/0254536 A1
(43) Pub. Date: Aug. 7, 2025

(54) SYSTEMS AND METHODS FOR NETWORK TOPOLOGY CONFIGURATION AND MANAGEMENT

(71) Applicant: PLUME DESIGN, INC., Palo Alto, CA (US)

(72) Inventors: Saidhiraj AMURU, Manikonda (IN); Badri Srinivasan SAMPATHKUMAR, Fremont, CA (US)

(21) Appl. No.: 18/435,123

(22) Filed: Feb. 7, 2024

(51) Int. Cl. H04W 24/02; H04W 84/12

(52) U.S. Cl. CPC H04W 24/02; H04W 84/12

(57) ABSTRACT

Disclosed are systems and methods that provide a decision-intelligence (DI)-based, computerized framework for automatically and dynamically determining a quantity and positioning of APs within a location, for which an optimized WiFi network can be realized. The disclosed framework can operate by determining a floor plan/layout of a location using tracked and analyzed channel metrics from the various WiFi devices in the location. Based upon the computational analysis of such metrics, the framework can identify the ideal spots for signal coverage, detect weak/dead spots for signal coverage, close the coverage hole gaps in the house, and the like. Thus, the network topology of a WiFi network, inclusive of the number of nodes in the topology, as well as the quantity of nodes, can be determined, configured and applied to a location, which can control how a location's network operates.

### FIELD OF THE DISCLOSURE

The present disclosure is generally related to network management at a location via Wireless Fidelity (Wi-Fi or WiFi) data, and more particularly, to a decision intelligence (DI)-based computerized framework for deterministically performing advanced network management via a location's determined, configured and implemented network topology.

### SUMMARY OF THE DISCLOSURE

In a typical WiFi Mesh network that consists of multiple wireless Access Points (AP) (also referred to as AP devices, used interchangeably), users face a challenge in figuring out the physical positioning within a location (e.g., home, small business, and the like) where each AP should be placed for optimal network performance. Such placement should be such that the Mesh network delivers whole location coverage without any dead spots, as well as ensuring that throughput and latency characteristics, among other attributes/characteristics, of the network are reasonable at every location within the location.

Under conventional mechanisms, placement of APs happens either by a technician physically visiting a customer's location and doing a site survey, or by trial and error by the user placing APs in different locations (e.g., like one per room, for example). Such approach results in many technical issues, such as, for example, backhauls between APs being formed in 2.4 GHz band (due to poor channel characteristics) that brings down the throughput that can be delivered to the devices connected to those APs. In some instances, users may have to run an ethernet connection between the pods to obtain connectivity across certain portions of the location. Further, the ideal number of APs that are required to cover a given location must be manually performed, via the trial and error of a technician/user, in that placement and the quantity of APs are simply manipulated based on the detection of poor performance.

To that end, according to some embodiments, the disclosed systems and methods provide a novel computerized framework that can automatically and dynamically determine a quantity and positioning of APs within a location, for which an optimized WiFi network can be realized. According to some embodiments, the disclosed framework can operate by generating, creating, compiling, building or otherwise determining a floor plan/layout of a location using tracked and analyzed channel metrics from the various WiFi devices in the location. Based upon the computational analysis of such metrics, the disclosed framework can, among other technological benefits, for example, identify the ideal spots for signal coverage, detect weak/dead spots for signal coverage, close the coverage hole gaps in the house, inform users for the ideal placement of the WiFi routers in the location to have a good overall experience, and the like. As discussed in more detail below, the metrics can include, but are not limited to, wireless channel information, received signal strength and signal to noise ratio (SNR) compiled from communicated data from the various devices, among others, as the location.

According to embodiments of the instant disclosure, it should be understood that the discussion herein that references a location can correspond to, but not be limited to, a home, office, building and/or any other type of definable structure and/or geographic location for which a wireless network (e.g., WiFi network, for example) can be provided and/or associated therewith.

According to some embodiments, a method is disclosed for a DI-based computerized framework for deterministically performing advanced network management via a location's determined, configured and implemented network topology. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for deterministically performing advanced network management via a location's determined, configured and implemented network topology.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIGS. 1A-1B are block diagrams of example configurations within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. WiFi technology is evolving at a rapid pace with many new features being introduced to enhance user experience. Some of the features include, for example, MU-MIMO (multi-user, multiple input, multiple output), OFDMA (orthogonal frequency-division multiple access), MLO (multi-link operation), among others. In order for these features to be useful and reap benefits, a WiFi network service provider must ensure that users have a uniform network coverage and network experience throughout their location (e.g., home) with a threshold satisfying SNR. In order for this to happen, a number of parameters must be taken into account, such as, for example, wireless channel behavior, interference behavior, number of devices connecting to the network, throughput requirements for each of these devices, applications being used in the home, and the like. Furthermore, as devices (e.g., mobile devices) move around a location, there could be potential handovers that need to be handled inside the location considering the size of the location. For example, when video conferencing or voice calls are handled over this network, call drops should not happen and the quality of experience should be acceptable in every place. This is possible only when the network is planned well in the location.

Accordingly, this can be possible when the location's layout is known prior to the placement of required AP devices. Most solutions available currently use a layout (or floor plan, user interchangeably) that is provided by the user as an input. However, besides this potentially being a privacy concern, not many users are willing to update the network provider with their floor plans. Additionally, not many users can accurately provide a floor plan for a location (e.g., size, dimensions, configuration of rooms, and the like). In some other cases, a manual effort from the content service provider (CSP) side may be required, in that a technician may visit the home and identify received signal strength indicator (RSSI) information/data manually at various places in the house and further suggest to the user about where to place the AP devices, repeaters, and the like.

Accordingly, as discussed herein, the disclosed framework can leverage WiFi metrics from WiFi devices in/around the location, whereby a floor plan/layout of the location can then be securely determined. As provided below in more detail, the disclosed framework can determine, configure and apply a network topology of a location's WiFi network, inclusive of the number of nodes in the topology, as well as the quantity of nodes, which is optimized to eliminate and/or reduce dead/weak spots within the network while maximizing connectivity across the location's physical area (e.g., both in x, y and z coordinates).

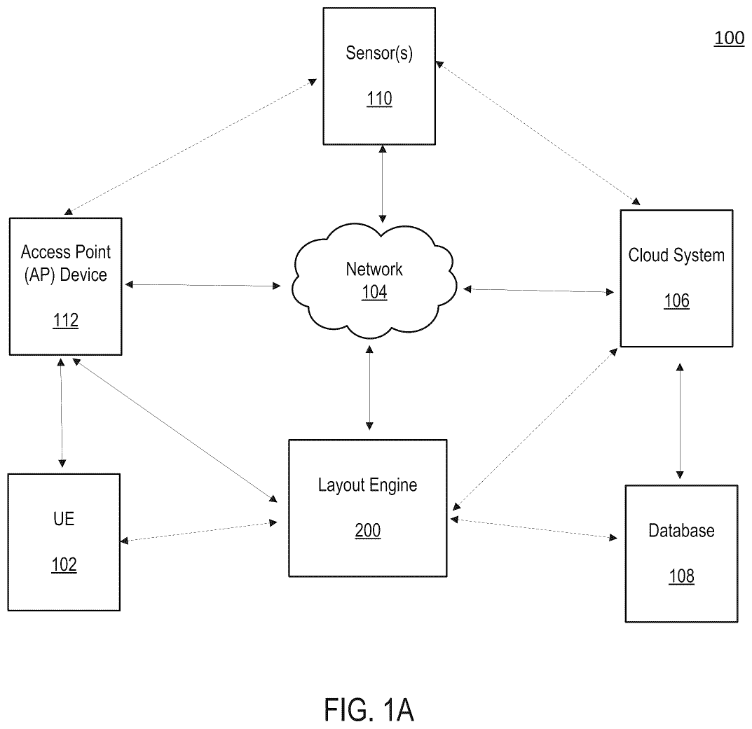

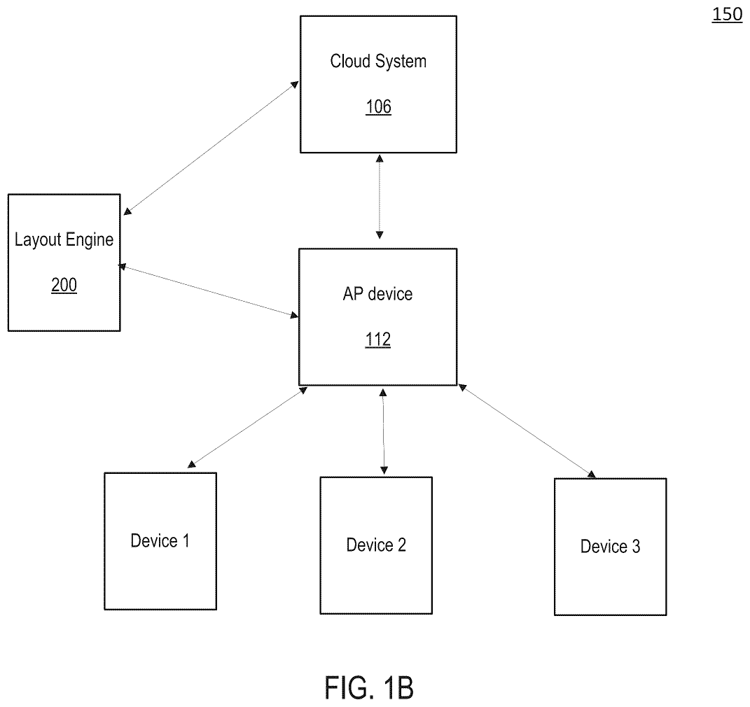

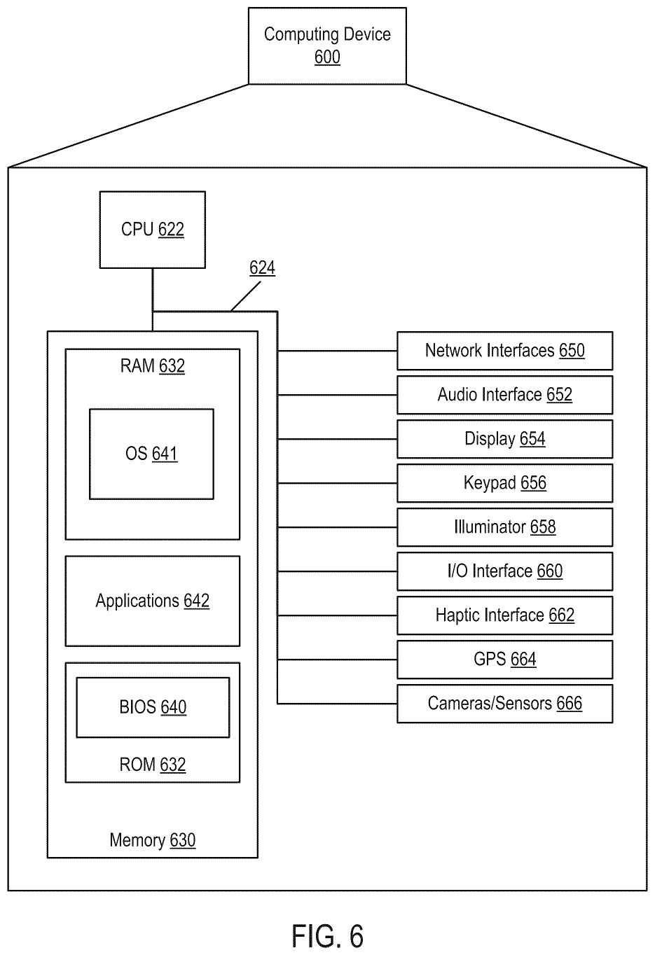

With reference to FIG. 1A, system 100 is depicted which includes user equipment (UE) 102 (e.g., a client device, as mentioned above and discussed below in relation to FIG. 6), AP device 112, network 104, cloud system 106, database 108, sensors 110 and layout engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1A.

According to some embodiments, UE 102 can be any type of device, such as, but not limited to, a mobile phone, tablet, laptop, sensor, Internet of Things (IoT) device, wearable device, autonomous machine, smart television, media streaming device, game console, and any other device equipped with a cellular or wireless or wired transceiver.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

According to some embodiments, sensors 110 can correspond to any type of device, component and/or sensor associated with a location of system 100 (referred to, collectively, as “sensors”). In some embodiments, the sensors 110 can be any type of device that is capable of sensing and capturing data/metadata related to activity of the location. For example, the sensors 110 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device (e.g., a paired smart ring). In some embodiments, sensors 110 can be associated with any device connected and/or operating on cloud system 106 (e.g., a cloud-based device, such as a server that collects information related to the location, for example).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider (e.g., Plume Design®), which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or layout engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

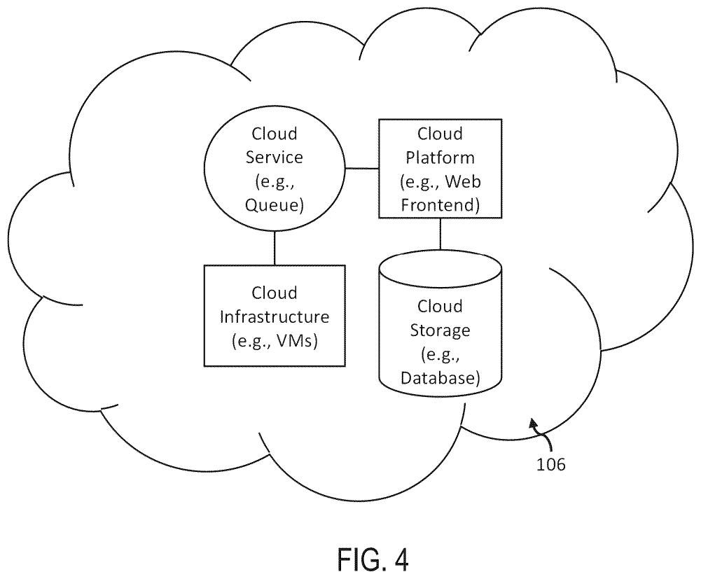

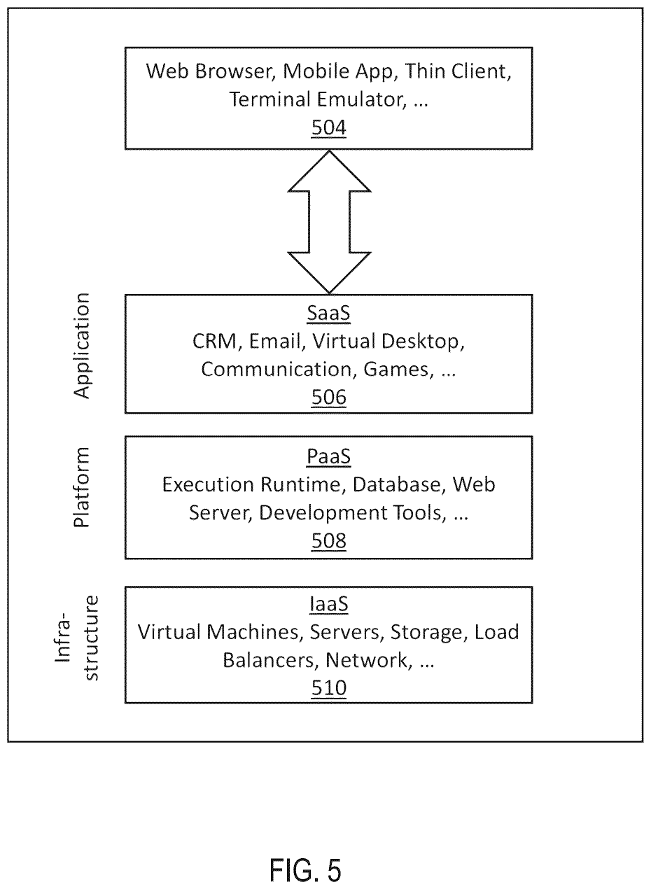

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1A, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Layout engine 200, as discussed above and further below in more detail, can include components for the disclosed functionality. According to some embodiments, layout engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, layout engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, layout engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112 and/or UE 102 (and/or sensors 110). In some embodiments, such application may be a web-based application accessed by AP device 112 and/or UE 102, and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on AP device 112, UE 102 and/or sensors 110.

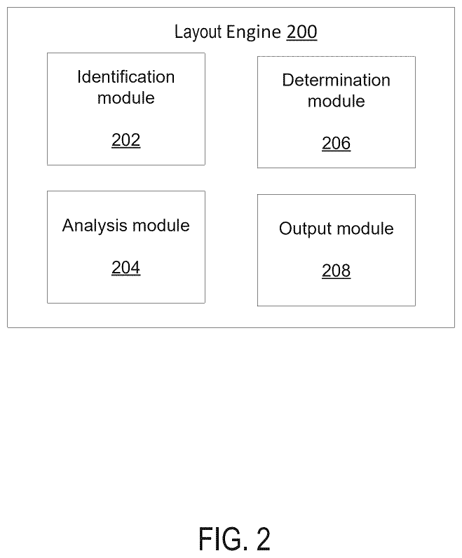

As illustrated in FIG. 2, according to some embodiments, layout engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 1B, depicted is a non-limiting example system embodiment 150. According to some embodiments, embodiment 150 includes cloud system 106 (e.g., which can include a cloud controller, for example), AP device 112, layout engine 200 (e.g., which as mentioned above and discussed in more detail below, can operate as a network management interface controller), and devices 1, device 2 and device 3. It should be understood that while embodiment 150 is depicted as including such components, it should not be construed as limiting, as one of ordinary skill in the art would readily understand that varying numbers of UEs, AP devices, cloud systems, and the like (e.g., as discussed with reference to FIG. 1A, supra) can be utilized; however, for purposes of explanation, the example discussed with reference to embodiment 150 is discussed in relation to the example depiction in FIG. 1B).

According to some embodiments, device 1, device 2 and device 3 can respectively correspond to a iRobot Roomba®, smart television and smart thermostat. Thus, as discussed in more detail below, as device 1 (e.g., smart vacuum) traverses the location associated with embodiment 150 (e.g., a user's home, for example), the network connection between device 1 and AP device can be leveraged, such that RSSI data, and ultimately WiFi metrics data can be collected, that can be analyzed by cloud system 106 (e.g., via execution of engine 200), such that a floorplan/layout of the location is mapped and generated. Such floorplan, as discussed below, can be stored as a data structure, whereby upon its analysis by engine 200 based at least in part on the number of devices (and/or AP devices 112), a determination can be made as to how to configure the network topology (e.g., a number of AP devices and their placement within the location). As provided below, such placement can be based on x, y and/or z coordinates of a location (e.g., on the first floor, second floor, and the like, and in which particular room, and the like).

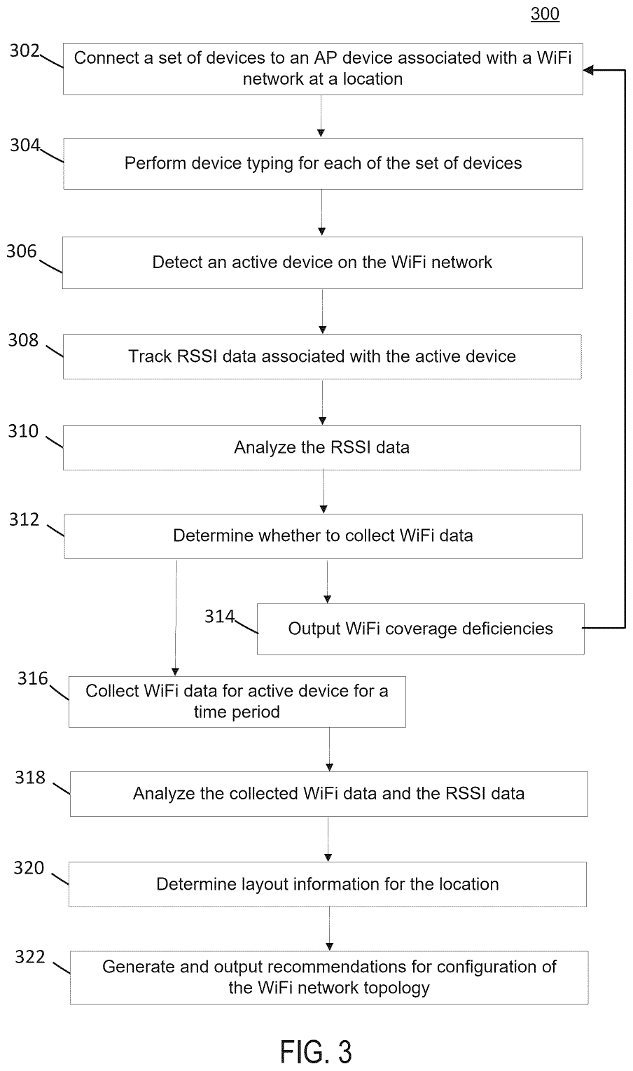

Turning to FIG. 3, Process 300 provides non-limiting example embodiments for the disclosed network management functionality, as discussed herein. As provided below, the disclosed framework's configuration and implementation can provide a computerized suite of localization tools for managing network configurations based on the determined layout (or floorplan) of a location (e.g., home, office and/or other physical locations for which a computerized network is provided).

According to some embodiments, Steps 302-306 of Process 300 can be performed by identification module 202 of layout engine 200; Steps 308, 310, 316 and 318 can be performed by analysis module 204; Steps 312 and 320 can be performed by determination module 206; and Steps 314 and 322 can be performed by output module 208.

According to some embodiments, Process 300 begins with Step 302 where engine 200 can identify and connect a set of devices to an AP device at a location. As discussed above at least with reference to FIGS. 1A-1B, an AP device can be associated with and/or provide access to such devices to a WiFi network for a location (e.g., home, office, and the like).

According to some embodiments, when a device (e.g., UE 102) connects to a WiFi AP device, the connection begins by the device scanning for available wireless networks in its vicinity. This can involve detecting the broadcasted service set identifier (SSID) signals of nearby WiFi AP devices. Once a specific WiFi network is selected, the device proceeds to the authentication phase for secured networks. Authentication typically involves entering a password or other security credentials. After successful authentication, the device associates itself with the selected WiFi access point. During this association, the device and the access point establish a connection and negotiate communication parameters. In some embodiments, if the WiFi network uses TCP/IP, the device may obtain an IP address from the AP device to enable communication within the network and access to the internet. Once these steps are completed, the device is effectively connected to the WiFi AP device, allowing it to communicate with other devices on the same network and access online resources through the AP device's connection to the internet.

In Step 304, engine 200 can perform device typing for each of the set of devices, which is performed to determine a type and/or the capabilities of each of the set of devices. For example, engine 200 can execute mechanisms to identify and categorize the set of devices connected to the location's network. For example, when a device connects to the network, the device typically sends a DHCP request to obtain an IP address, and this request may include information about the device's type, model and/or capabilities. Address resolution protocol (ARP), as executed by engine 200, can map the IP addresses to MAC (Media Access Control) addresses, contributing to the identification process. In some embodiments, engine 200 can implement advanced network monitoring tools and software that can analyze, for example, network traffic patterns, device behavior and characteristics. In some embodiments, engine 200 can execute machine learning (ML) algorithms, as discussed below, to recognize device fingerprints based on unique patterns in their network activity. Accordingly, in some embodiments, such combination of protocols, tools and algorithms can enable engine 200 to create a profile of connected devices, enabling them to manage the network effectively, enforce security policies and optimize performance based on the specific requirements of each device type.

In Step 306, engine 200 can perform network monitoring operations, whereby upon network activity for a particular device occurring at or above a threshold value, engine 200 can detect an active device on the WiFi network. In some embodiments, an active device can correspond to a device communicating at least a threshold amount of data (e.g., sending and/or receiving over the network) for a time period. In some embodiments, an active device can correspond to a device moving at least a threshold value of coordinates (or geographic area) within a location. Accordingly, in some embodiments, the detection via the monitoring can involve detecting an RSSI signal from at least one of the connected devices (from Step 302) satisfying a threshold value, such that the threshold satisfying RSSI signal indicates movement by the device at and/or around the location. In some embodiments, the threshold for movement can be based on the device typing, whereby certain thresholds can correspond to types of movement devices are typically performing.

In Step 308, engine 200 can track the RSSI signal data (or RSSI data, used interchangeably) for the active device. In some embodiments, such tracking can occur continuously and/or according to a predetermined time period (e.g., every 15 seconds, for example). In some embodiments, such tracking can conclude after a predetermined time (e.g., after 30 minutes) and/or can conclude upon the detection of the device not moving for at least n seconds (e.g., 90 seconds). In some embodiments, such determination of the device not moving can be based on the RSSI data falling below the threshold value for at least the n seconds.

In some embodiments, such “not moving” can correlate to the device moving out of range of the AP device (e.g., the RSSI data falls below the threshold value). In some embodiments, processing can proceed back to Step 302 for another AP device to continue the tracking of the active device.

According to some embodiments, the tracked data in Step 308 can include, but not be limited to, RSSI data, channel values, and the like, which can be continuously and/or periodically exchanged between the active device and the AP device. In some embodiments, the tracked RSSI data (and/or other data) can be stored in database 108. In some embodiments, engine 200, via the Cloud (e.g., cloud system 106, discussed supra) can assimilate all of the tracked metrics on a value-based granularity (e.g., fine granularity). In some embodiments, such data can be subject to computations to normalize the data, which can include, but not be limited to, averaging, weighting, noise removal, smoothing, and the like, and/or some combination thereof. For example, in some embodiments, engine 200 can execute a noise removal algorithm respective to the tracked and collected data.

In Step 310, engine 200 can analyze the tracked and collected RSSI data. In some embodiments, such analysis can be performed upon the completion of the tracking, upon a quantity of the RSSI data satisfying a quantity threshold, in real-time as it is collected, and the like, or some combination thereof.

Accordingly, engine 200 can perform computational analysis on the RSSI data for the active device(s). According to some embodiments, Step 310 can involve engine 200 analyzing the RSSI data, which can involve engine 200 executing a specific trained artificial intelligence (AI)/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Thus, based on the analysis of the WiFi data, in Step 310, engine 200 can determine whether to commence the collection of WiFi data. According to some embodiments, the analysis and determination (of Steps 310-312) can involve the determination of a RSSI heat map. The heat map can be configured as a data structure (or file, object or item), which can be electronically created and stored in database 108.

According to some embodiments, an RSSI heat map of a location can provide, when displayed within a user interface (UI), a visual representation that displays the signal strength of a WiFi network across different areas within that space. As discussed above, RSSI is a measure of the power level received by a device from an AP device, and a heat map, for example, provides a color-coded representation of these signal strength values. In some embodiments, for example, the heat map can use a gradient of colors (or patterns, or both) where warmer colors, such as red or orange, can indicate higher signal strength, while cooler colors like blue or green represent weaker signals. Accordingly, as the mapped area is traversed, the colors can change, whereby the displayed heat map can provide an intuitive visualization of signal strength variations. As discussed herein, such mapping type and functionality can provide understanding of the wireless coverage and identify potential areas with poor connectivity or dead zones. As discussed herein, the heat map helps in making informed decisions about AP device quantity and placement, antenna orientation, and other factors that influence the overall performance of a WiFi network in a specific location.

Accordingly, in Step 312, engine 200 can determine whether/when to track WiFi data (or metrics, used interchangeably) for the active device. In some embodiments, when the heat map indicates that the device is within the “cooler colors” (e.g., the RSSI data is weak (or below a threshold strength value)), coverage deficiencies can be detected. Thus, in Step 314, engine 200 can compile information related to the positional values of the device and/or AP device, and store such data in database 108. Such stored data can indicate weak spots of network coverage. In some embodiments, processing can recursively proceed back to Step 302 (or Step 306) to identify other connected devices that become active.

In some embodiments, when the heat map indicates that the device is within the “warmer colors” (e.g., the RSSI data is strong (or equal to and/or above the threshold strength value)), WiFi data can be tracked for the device. Thus, in Step 316, based on such determination, engine 200 can collect (in a similar manner as performed in Step 308, supra) WiFi data for the device.

According to some embodiments, as discussed above, such WiFi data can include, but is not limited to, SNR (e.g., reflecting the quality of the signal amidst background noise); channel utilization (e.g., assessing the busyness of the WiFi channel); data rate (e.g., indicating the speed of data transmission); latency (e.g., measuring the delay in data transfer); packet loss (e.g., reflecting the percentage of lost data packets); roaming events (e.g., tracking seamless transitions between AP devices); authentication and association times (e.g., measuring the efficiency of connection setup); device count (e.g., monitoring the number of connected devices); retry rates (e.g., indicating the frequency of data packet retransmissions), bandwidth, and the like, or some combination thereof.

In some embodiments, such WiFi data can include network throughput, which refers to the amount of data that can be transmitted over a network in a given amount of time. Throughput is a measure of the actual data transfer rate and represents the effective bandwidth available for communication between devices on a network. Throughput is influenced by various factors such as, but not limited to, network congestion, latency, packet loss and the efficiency of the network protocols and hardware. In some embodiments, such WiFi data can also include the collection of further RSSI data.

In some embodiments, the WiFi data can include wireless channel information related to, but not limited to, channel gains, channel delay spread, doppler behavior, angle of arrivals, time of arrivals, and the like. As discussed below, such data, among other data discussed herein, can enable the x, y, and z coordinates of the layout of the location (e.g., floors, rooms, height of the floors/rooms, and the like, for example).

In Step 318, engine 200 can analyze the collected WiFi data, which can be performed in a similar manner as discussed above in at least Step 310. That is, engine 200 can execute any type of the AI/ML models discussed above to perform the computational analysis of the collected WiFi data.

Thus, in Step 320, engine 200 can, based on the AI/ML analysis of the WiFi data from Step 318, determine layout information of the location. The layout information can include, but is not limited to, size (e.g., square footage), shape, geographic location, dimensions, number of floors, number of rooms, and the like. As discussed herein, the layout information ensures that the front haul and back haul links between the AP device(s) and connected set of devices have WiFi metrics (e.g., capacity, coverage, and the like) satisfying corresponding connectivity thresholds.

Accordingly, the layout (or floorplan) of a location can be configured as a data structure (or other type of electronic file), which provides a visual representation of the spatial layout and architectural details of a specific location. According to some embodiments, the layout can include information, such as, but not limited to, the arrangement of rooms, walls, doors, floors, windows and other structural elements within the space. The layout can also indicate the dimensions of rooms, the positioning of furniture, elevations of/within the location and the locations of amenities/fixtures (e.g., electrical outlets and plumbing fixtures), and the like. For example, when an elevation angle of a WiFi signal is at or above a threshold, engine 200 can determine the device's movement to correspond to a particular floor (e.g., first or second floor, for example), as discussed herein.

Additionally, the layout can provide information related to insights into the flow of foot traffic, potential areas for WiFi signal coverage, and the overall design of the environment.

According to some embodiments, the layout information can include indicators of zones, which can correspond to types of areas within the location (e.g., kitchen, bedroom, TV room, garage, and the like) and/or types of activity (e.g., time periods of high traffic, app prioritization per time, application type and/or user, and the like), and the like. Thus, such zones can account for such information when determined types and/or quantities of connectivity are required, so that high-traffic areas/zones can be configured/positioned with AP devices that enable such required network access.

Accordingly, as discussed above, the layout information (e.g., layout data structure) can be stored in database 108.

And, in Step 322, engine 200 can generate and output recommendations for configuration (and/or modification) of the WiFi network topology. According to some embodiments, the output recommendations, which can be generated based on the determined layout being further analyzed via the AI/ML models discussed herein, can identify positions and/or quantities of AP devices in/around the location so as to maximize network coverage while minimizing (or at least reducing) any coverage deficiencies (e.g., dead zones). According to some embodiments, such recommendations can be electronically communicated to the set of devices and/or the AP device, for which positioning information can be electronically communicated to a configuring user of the location. In some embodiments, the AP device(s) may be electronically controlled such that the recommended configuration may be required to be followed for the AP device to be enabled to allow devices to connect therewith (e.g., for example, the AP device may not enable UEs to connect and/or provide network connectivity thereto unless the AP is positioned as recommended as per the layout's indication, as discussed herein).

According to some embodiments, the recommendations can be output as messages to a user, via the user's device and/or an account of the user. The messages, for example, can request information as to the layout information. Such questions can be used to confirm the layout and/or update the layout (e.g., how many floors in location; how many rooms; approximate square footage, is there a yard and plan to use WiFi in the yard; and the like). In some embodiments, such questions can be compiled and communicated as part of Step 320, whereby the determination of the layout information can be based, at least in part, on the responses to the user (e.g., the AI/ML determined layout can be modified and/or curated based on the responses from a user).

In some embodiments, the messages, as mentioned above, can provide indicators for where the AP devices, and how many AP devices, can be located within the location; and in some embodiments, how many devices can efficiently connect to the AP device without a loss of expected network connectivity (e.g., throughput per device at least a threshold value can be maintained).

According to some embodiments, the processing of Process 300 can recursively be performed, which can be performed based on, but not limited to, a request, connection of a new device (e.g., UE, sensor and/or AP device), periodically and/or continuously. Such recursive operations can enable the dynamic network configurations of the network to adapt and ensure connectivity is maintained over the course of a time period.

Thus, the disclosed systems and methods provide intuitive mechanisms for network topologies and/or configurations to be determined, suggested/recommended and/or automatically configured for which optimal WiFi connectivity can be provided therefrom.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising steps of:
identifying a device connected to an access point (AP) device, the AP device providing a Wireless Fidelity (WiFi) network for a location;
collecting WiFi data for the device communicated between the device and the AP device;
analyzing the collected WiFi data, and determining, based on the analysis, layout information of the location, the layout information comprising indicators of a spatial layout and architectural details of the location;
determining, based on the layout information, a configuration of the WiFi network; and
configuring, based on the determined configuration, the WiFi network, the configuration comprising functionality enabling optimized network connectivity across all areas of the location.
   Aspect 2. The method of aspect 1, wherein the WiFi data comprises at least one of received signal strength indictor (RSSI) data, signal to noise ratio (SNR) data, wireless channel information, ranging information, channel utilization, latency, roaming, authentication, retry rates, throughput and bandwidth.
   Aspect 3. The method of aspect 2, further comprising:
collecting RSSI data for the device;
analyzing the RSSI data; and
performing the collection of the WiFi data based on the analysis of the RSSI data.
   Aspect 4. The method of aspect 1, wherein the layout information comprises information related to at least one of arrangement of rooms, walls, doors, floors, windows, dimensions of rooms, positioning of furniture, elevations within the location, and locations of amenities and fixtures.
   Aspect 5. The method of aspect 1, further comprising:
determining, based on the analysis, network coverage details for each area within the location, the coverage details providing indicators of whether coverage holes exist respective to each area, wherein the determination of the configuration of the WiFi network is based on the determined network coverage details.
   Aspect 6. The method of aspect 1, wherein the configuration of the WiFi network corresponds to a network topology, wherein the network topology provides an indicator of a required number of AP devices and positions of the AP devices within the location to ensure that coverage holes are not present within connectivity of the WiFi network.
   Aspect 7. The method of aspect 1, wherein the configuration of the WiFi network provides a network implementation for front haul and back haul links between the device and the AP device with WiFi connectivity metrics satisfying connectivity thresholds.
   Aspect 8. The method of aspect 1, further comprising:
determining that the device is active within the location, wherein the active determination corresponds to at least one of activity on the WiFi network and movement within the location, wherein the collection of WiFi data is based on the active determination.
   Aspect 9. The method of aspect 1, wherein the identified device is part of a set of devices connected to the AP device, wherein the steps are performed for each other device in the set of devices.
   Aspect 10. The method of aspect 1, wherein the device is a mobile device of a user.
   Aspect 11. The method of aspect 1, wherein the steps are performed by a cloud.
   Aspect 12. The method of aspect 1, wherein the location corresponds to a home of a user.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising the steps of:
identifying a device connected to an access point (AP) device, the AP device providing a Wireless Fidelity (WiFi) network for a location;
collecting WiFi data for the device communicated between the device and the AP device;
analyzing the collected WiFi data, and determining, based on the analysis, layout information of the location, the layout information comprising indicators of a spatial layout and architectural details of the location;
determining, based on the layout information, a configuration of the WiFi network; and
configuring, based on the determined configuration, the WiFi network, the configuration comprising functionality enabling optimized network connectivity across all areas of the location.

2. The method of claim 1, wherein the WiFi data comprises at least one of received signal strength indictor (RSSI) data, signal to noise ratio (SNR) data, wireless channel information, ranging information, channel utilization, latency, roaming, authentication, retry rates, throughput and bandwidth.

3. The method of claim 2, further comprising:
collecting RSSI data for the device;
analyzing the RSSI data; and
performing the collection of the WiFi data based on the analysis of the RSSI data.

4. The method of claim 1, wherein the layout information comprises information related to at least one of arrangement of rooms, walls, doors, floors, windows, dimensions of rooms, positioning of furniture, elevations within the location, and locations of amenities and fixtures.

5. The method of claim 1, further comprising:
determining, based on the analysis, network coverage details for each area within the location, the coverage details providing indicators of whether coverage holes exist respective to each area, wherein the determination of the configuration of the WiFi network is based on the determined network coverage details.

6. The method of claim 1, wherein the configuration of the WiFi network corresponds to a network topology, wherein the network topology provides an indicator of a required number of AP devices and positions of the AP devices within the location to ensure that coverage holes are not present within connectivity of the WiFi network.

7. The method of claim 1, wherein the configuration of the WiFi network provides a network implementation for front haul and back haul links between the device and the AP device with WiFi connectivity metrics satisfying connectivity thresholds.

8. The method of claim 1, further comprising:
determining that the device is active within the location, wherein the active determination corresponds to at least one of activity on the WiFi network and movement within the location, wherein the collection of WiFi data is based on the active determination.

9. The method of claim 1, wherein the identified device is part of a set of devices connected to the AP device, wherein the steps are performed for each other device in the set of devices.

10. The method of claim 1, wherein the device is a mobile device of a user.

11. The method of claim 1, wherein the steps are performed by a cloud.

12. The method of claim 1, wherein the location corresponds to a home of a user.

13. A system comprising:
a processor configured to:
identify a device connected to an access point (AP) device, the AP device providing a Wireless Fidelity (WiFi) network for a location;
collect WiFi data for the device communicated between the device and the AP device;
analyze the collected WiFi data, and determine, based on the analysis, layout information of the location, the layout information comprising indicators of a spatial layout and architectural details of the location;
determine, based on the layout information, a configuration of the WiFi network; and
configure, based on the determined configuration, the WiFi network, the configuration comprising functionality enabling optimized network connectivity across all areas of the location.

14. The system of claim 13, wherein the WiFi data comprises at least one of received signal strength indictor (RSSI) data, signal to noise ratio (SNR) data, wireless channel information, ranging information, channel utilization, latency, roaming, authentication, retry rates, throughput and bandwidth.

15. The system of claim 14, wherein the processor is further configured to:
collect RSSI data for the device;
analyze the RSSI data; and
perform the collection of the WiFi data based on the analysis of the RSSI data.

16. The system of claim 13, wherein the layout information comprises information related to at least one of arrangement of rooms, walls, doors, floors, windows, dimensions of rooms, positioning of furniture, elevations within the location, and locations of amenities and fixtures.

17. The system of claim 13, wherein the processor is further configured to:
determine, based on the analysis, network coverage details for each area within the location, the coverage details providing indicators of whether coverage holes exist respective to each area, wherein the determination of the configuration of the WiFi network is based on the determined network coverage details.

18. The system of claim 13, wherein the configuration of the WiFi network corresponds to a network topology, wherein the network topology provides an indicator of a required number of AP devices and positions of the AP devices within the location to ensure that coverage holes are not present within connectivity of the WiFi network.

19. The system of claim 13, wherein the configuration of the WiFi network provides a network implementation for front haul and back haul links between the device and the AP device with WiFi connectivity metrics satisfying connectivity thresholds.

20. A non-transitory computer-readable storage medium tangibly encoded with computer-executable instructions that when executed by a processor, perform a method comprising:
identifying a device connected to an access point (AP) device, the AP device providing a Wireless Fidelity (WiFi) network for a location;
collecting WiFi data for the device communicated between the device and the AP device;
analyzing the collected WiFi data, and determining, based on the analysis, layout information of the location, the layout information comprising indicators of a spatial layout and architectural details of the location;
determining, based on the layout information, a configuration of the WiFi network; and
configuring, based on the determined configuration, the WiFi network, the configuration comprising functionality enabling optimized network connectivity across all areas of the location.
